(19) United States
(12) Patent Application Publication
(10) Pub. No.: US 2012/0070603 A1
(43) Pub. Date: Mar. 22, 2012

(54) SCREEN PROTECTIVE STICKER

(76) Inventor: FU-YI HSU, TAITUNG COUNTY (TW)

(21) Appl. No.: 12/886,731

(22) Filed: Sep. 21, 2010

(51) Int. Cl. B32B 7/02; C09J 7/02

(52) U.S. Cl. 428/41.8; 428/212

(57) ABSTRACT

A screen protective sticker structure comprises a plurality of screen protectors overlaying each other. Each screen protector has an optical film and an adhesion layer disposed on the optical film. Each adhesion layer has certain stickiness, and the stickiness of the adhesion layers is increasing or equal from the top layer to the bottom layer. The adhesion layer of the outer layer is overlayingly disposed on the top surface of the optical film of the inner protector. Thus, the instant disclosure can be used easily and improved protective ability for a display screen.

### BACKGROUND OF THE INVENTION

1. Field of the Invention

The present invention relates to a protective structure for a screen display, and particularly to a protective sticker structure for disposing on a screen.

2. Description of Related Art

Modern electronic devices often have screens for displaying operating information of the electronic devices. A popular choice for such screen is a LCD screen, which possesses advantages such as thin and light. However, the delicate LCD screens are prone to scraping or bumping damages. Thus, various protective stickers are introduced for applying on the LCD screens to improve their anti-scraping ability and anti-bumping ability.

The screen protector has been widely applied to electronic devices such as cell phones, cameras, or portable media players. The existing screen protectors on the market are single-layered transparent film stickers made of plastic material. Conventionally, screen protector has an adhesion layer disposed on a bottom thereof, and a release film is bonded on the said adhesion layer. When a user wants to use the screen protector, he/she needs to remove the lease film from the screen protector and dispose the adhesion layer of the protective sticker onto the screen. However, as the screen protective sticker itself is damaged, it needs replacement as well. It is inconvenient for a user having to regularly take the trouble and effort to replace the damaged protective stickers.

Therefore, the invention provides a screen protective structure to mitigate and/or obviate the aforementioned problems.

### SUMMARY OF THE INVENTION

An object of the instant disclosure is to provide a screen protective structure. Particularly, the instant disclosure provides a more convenient and more effective screen protective structure.

The screen protective structure comprises a plurality of screen protectors bonded with each other. Each screen protector has an optical film and an adhesion layer disposed on the optical film. Each adhesion layer is of certain stickiness; and the stickiness of the adhesion layers is decreasing or equal from the top layer to the bottom layer. And, one of any two corresponding screen protectors is bonding to the optical film of the other one by the adhesion layer.

The instant disclosure has several features, includes as follows. (1) When the top screen protector is damaged, removing the top screen protector and the screen protective structure will protect the screen continuously, thereby the instant disclosure only needs one release film. (2) The screen protective structure is multilayer structure, so the screen protective structure can provide an anti-scraping ability and an anti-bumping ability better than the prior art.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1A is a schematic view of using the optical film of the present invention;

FIG. 1B is a schematic view of the present invention as the optical film is the plastic film;

FIG. 1C is a schematic view of the present invention as the optical film is the anti-scratch film;

FIG. 1D is a schematic view of the present invention as the optical film is the anti-glare film;

FIG. 1E is a schematic view of the present invention as the optical film is the anti-reflective film;

FIG. 1F is a schematic view of the present invention as the optical film is the anti-fingerprint film;

FIG. 1G is a schematic view of the present invention as the optical film is the anti-peeping film;

FIG. 1H is a schematic view of the present invention as the optical film is the specular reflection film;

FIG. 1I is a schematic view of the present invention as the optical film is the 3D-relief film;

FIG. 1J is a schematic view of the present invention;

FIG. 2 is a schematic view of the present invention applied to the notebook computer;

FIG. 3 is a schematic view of the present invention applied to the cell phone;

FIG. 4 is a schematic view of the second embodiment of the present invention;

FIG. 4A is a partial enlargement view of the second embodiment of the present invention;

FIG. 5 is a schematic view of the third embodiment of the present invention;

FIG. 6 is another using type view of the third embodiment of the present invention.

### DETAILED DESCRIPTION OF THE PREFERRED EMBODIMENTS

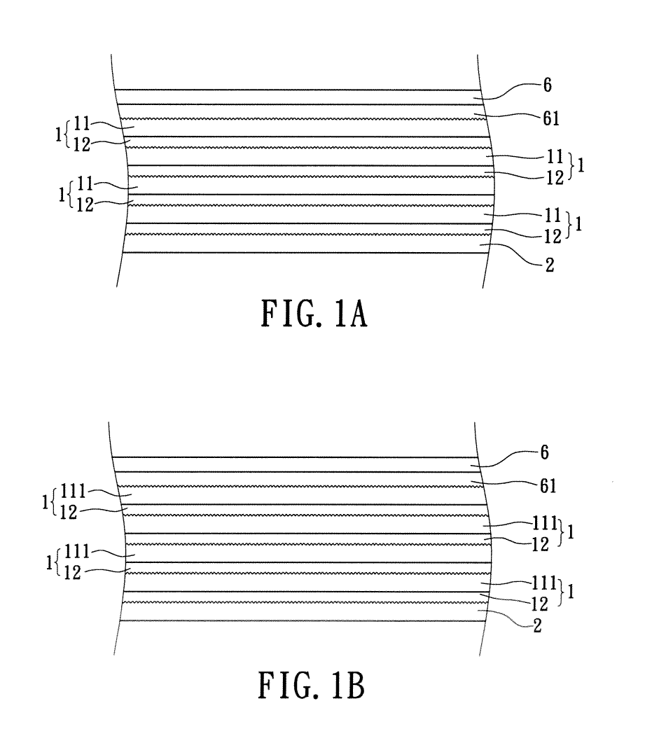

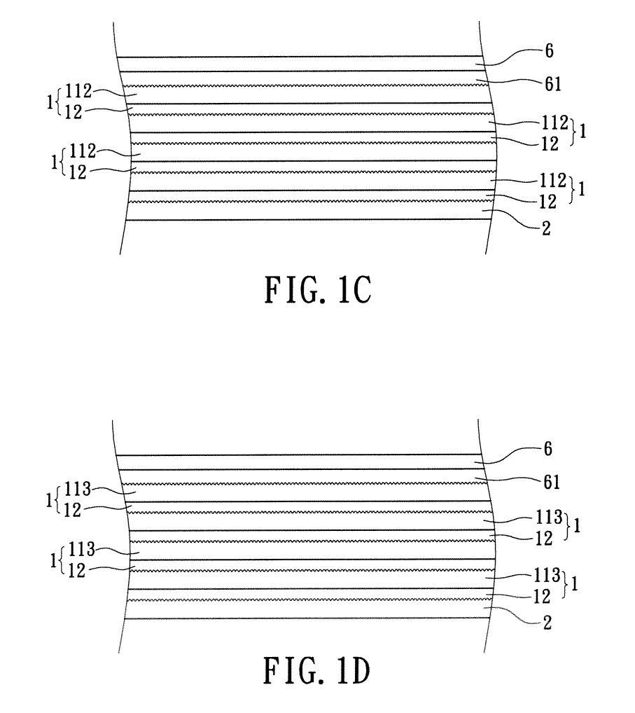

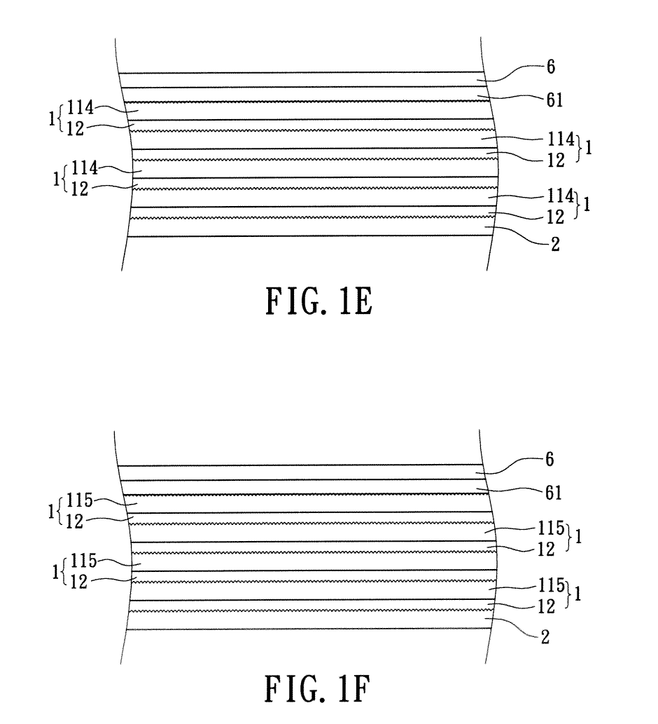

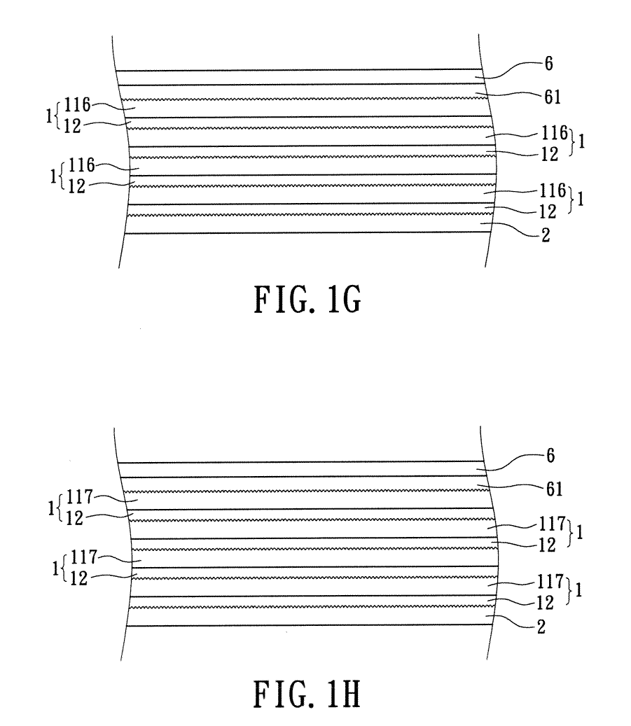

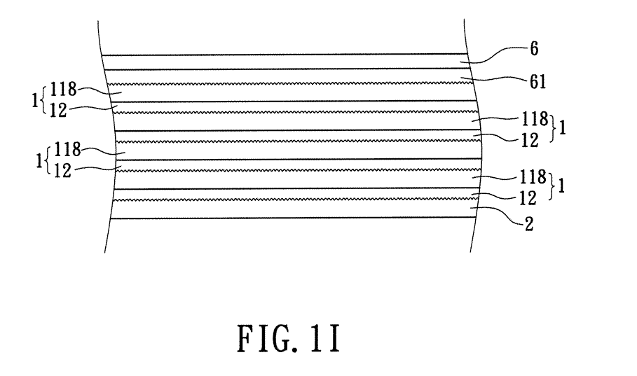

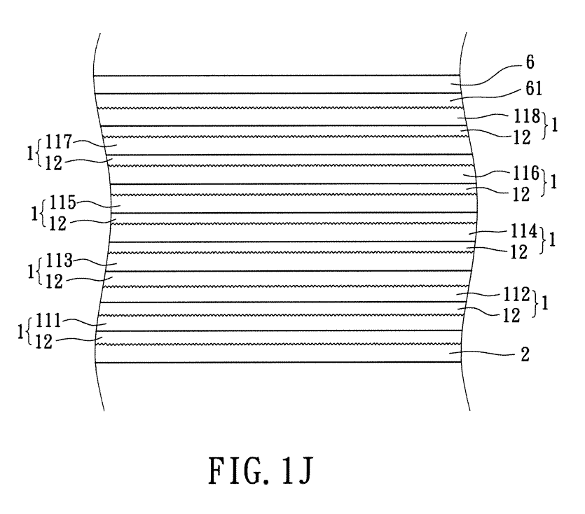

Referring to FIG. 1A to FIG. 3, illustrating a first embodiment of the instant disclosure. The first embodiment provides a screen protective sticker structure, which includes a plurality of screen protectors 1 overlaying each other. Each screen protector 1 has an optical film 11 and an adhesion layer 12 disposed on bottom of the optical film 11.

The optical films 11 of the screen protectors 1 are plastic films 111 (as FIG. 1B shown).

As FIG. 1C shown, the optical films 11 of the screen protectors 1 are anti-scratch films 112. The anti-scratch film 112 on the plastic film 111 can be achieved by a surface hardening process. The anti-scratch film 112 improves the anti-scraping ability of the screen protector 1 and enhances the hardness of the screen protector 1.

As FIG. 1D shown, the optical films 11 of the screen protectors 1 are anti-glare films 113. The anti-glare film 113 is made by the plastic film 111 with mat finish. The anti-glare film 113 may scatter reflecting lights from the display screens and thus providing users better view-ability in bright light environments.

As FIG. 1E shown, the optical films 11 of the screen protectors 1 are anti-reflective films 114. The anti-reflective film 114 makes the screen protector 1 to reduce a light reflective effect.

As FIG. 1F shown, the optical films 11 of the screen protectors 1 are anti-fingerprint films 115. The anti-fingerprint film 115 may reduce greasy fingerprint marks on the screen protector 1.

As FIG. 1G shown, the optical films 11 of the screen protectors 1 are anti-peeping films 116. The anti-peeping film 116 is made by a microlouver optical technology and a precision fitting technology to control light reflection. The anti-peeping film 116 makes the screen protector 1 presenting a dark view as looking at the screen protector 1 over a specific angle.

As FIG. 1H shown, the optical films 11 of the screen protectors 1 are specular reflection films 117. The specular reflection film 117 is made by a condenser show and highlight reflection technology.

As FIG. 1I shown, the optical films 11 of the screen protectors 1 are 3D-relief films 118. The 3D-relief film 118 is made by an optical resin, and the appearance of the 3D-relief film 118 has a 3D convex body, which is formed in a special construction method.

Furthermore, the optical films 11 can be an any combination from a plastic film 111, an anti-scratch film 112, an anti-glare film 113, an anti-reflective film 114, an anti-fingerprint film 115, an anti-peeping film 116, a specular reflection film 117, and a 3D relief film 118 (as FIG. 1J shown).

The adhesion layer 12 is bonded on bottom of the optical film 11, and the optical film 11 and the adhesion layer 12 can not be separated by human tearing. One of any two corresponding screen protectors 1 of the screen protective structure is bonding to the optical film 11 of the other one by the adhesion layer 12, and the two corresponding screen protectors 1 can be separated by human tearing.

Each adhesion layer 12 of the screen protectors 1 is of certain stickiness, and the stickiness of the adhesion layers 12 is decreasing or equal from the top adhesion layer 12 to the bottom adhesion layer 12 of the screen protectors 1. In other words, stickiness of the outer adhesion layer 12 of the two corresponding screen protectors 1 is weaker than the inner one. Therefore, when removing the top screen protector 1, the next screen protector 1 bonded by the top screen protector 1 would not be removed at the same time.

The adhesion layers 12 are in an electrostatic adsorption type or a pasting type. The adhesion layers 12 can tear and post repeatedly, and the adhesion layers 12 do not have defective gum.

The screen protective structure further has a release film 2 bonded on the adhesion layer 12 of the bottom screen protector 1. And, the screen protective structure further has a protective film 6 and an adhesion layer 61 bonded on the protective film 6, and the said adhesion layer 61 is bonded on the optical film 11 of the top screen protector 1. Therefore, when transporting the screen protective structure, the protective film 6 can prevent the screen protector 1 to be damaged.

When using the screen protective structure, tearing the lease film 2 at first, and taking the adhesion layer 12 of the bottom screen protector 1 to bond on a screen of an electronic device 3. If a bubble (not shown) is formed between the adhesion layer 12 of the bottom screen protector 1 and the screen of the electronic device 3, the adhesion layer 12 of the bottom screen protector 1 can be torn and posted repeatedly until the bubble disappeared. Finally, removing the protective film 6.

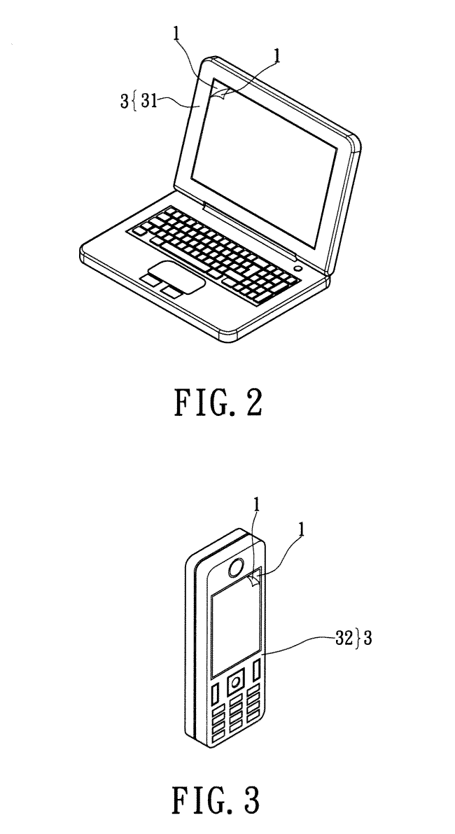

Size of the screen protective structure can be produced and design according to user demand. The electronic device 3 is a notebook computer 31 (as FIG. 2 shown), a cell phone 32 (as FIG. 3 shown), a camera, a TV, an e-book, a calculator, a watch, a phone, a refrigerator, a portable media player, a portable game console, a tool machine, a PDA, a handheld GPS, or a display and so on (not shown). Besides, amount of the screen protectors 1 of the screen protective structure can be produced and design according to user demand, and thickness of the screen protective structure is controlled in a range. Therefore, when the screen protective structure is bonded on the screen of the electronic device 3, the screen protective structure is higher than the screen of the electronic device 3 inconspicuously. Furthermore, the screen protective structure can be bonded on a touch screen (not shown) for protecting the touch screen.

The screen protective structure is a multilayer structure, so the screen protective structure can provide an anti-scraping ability and an anti-bumping ability better than the prior art. When the top screen protector 1 is damaged, removing the top screen protector 1 and the screen protective structure will protect the screen continuously, and it only needs one release film 2.

Besides, the screen protective structure can take off the top screen protector 1 to bond on the screen of the electronic device 3. Therefore, the instant disclosure can be divided to several screen protectors 1 for protecting several screens by using one release film 2, whereby reducing the waste release film 2.

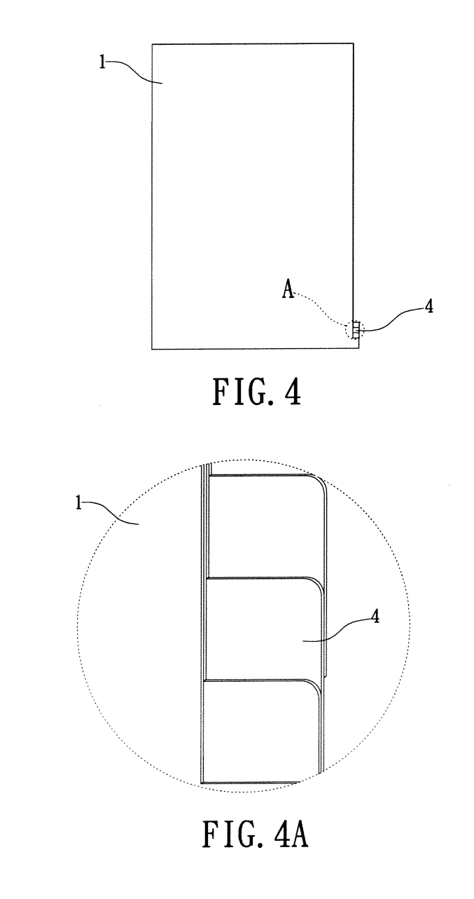

Referring to FIG. 4 and FIG. 4A, illustrating a second embodiment of the instant disclosure. The differences between the second embodiment and the first embodiment are as follows. Each screen protector 1 has an index plate 4 formed on one side thereof, and the index plates 4 are arranged side by side. Therefore, user can remove the screen protector 1 or the screen protectors 1 that user wants to remove according to the index plates 4.

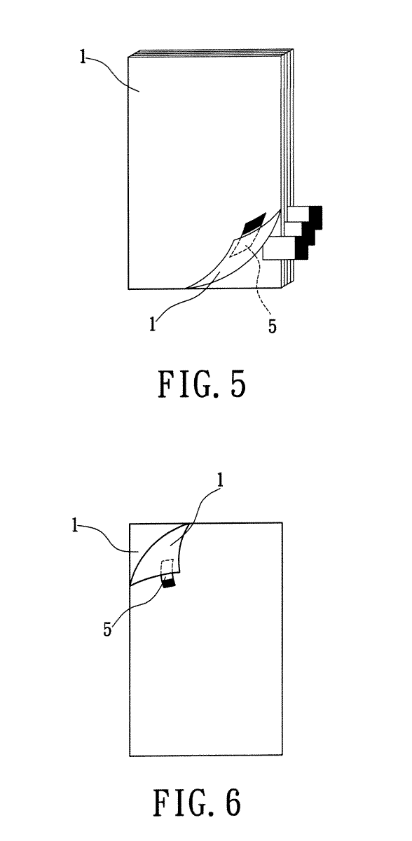

Referring to FIG. 5 and FIG. 6, illustrating a third embodiment of the instant disclosure. The differences between the third embodiment and the first embodiment are as follows. The screen protective structure further has a plurality of guide plates 5. The guide plates 5 are separately bonded on the optical films 11 of the screen protectors 1. Therefore, user can remove the screen protector 1 or the screen protectors 1 that user wants to remove according to the guide plates 5. Besides, as FIG. 6 shown, the guide plate 5 can be an assistant tool for removing the screen protector 1. For example, user takes one guide plate 5 to bond on the top screen protector 1, and taking off the guide plate 5 and the top screen protector 1.

The instant disclosure has several features, includes as follows. (1) When the top screen protector 1 is damaged, removing the top screen protector 1 and the screen protective structure will protect the screen continuously, thereby the instant disclosure only needs one release film 2. (2) The screen protective structure is multilayer structure, so the screen protective structure can provide an anti-scraping ability and an anti-bumping ability better than the prior art. (3) User can remove the screen protector 1 or the screen protectors 1 that user wants to remove according to the index plates 4 or the guide plates 5.

The description above only illustrates specific embodiments and examples of the present invention. The instant disclosure should therefore cover various modifications and variations made to the herein-described structure and operations of the present invention, provided they fall within the scope of the instant disclosure as defined in the following appended claims.

1. An overlaying screen protective sticker structure, comprising:
a plurality of screen protectors overlayingly disposed in a stack configuration, each screen protector comprising:
an optical film; and
an adhesion layer disposed on the optical film;
wherein the stickiness of each adhesion layer is increasing or equal from the top layer to the bottom layer.

2. The screen protective structure as claimed in claim 1, wherein the optical films are plastic films, anti-scratch films, anti-glare films, anti-reflective films, anti-fingerprint films, anti-peeping films, specular reflection films, or 3D relief films.

3. The screen protective structure as claimed in claim 1, wherein the optical films is an any combination from a plastic film, an anti-scratch film, an anti-glare film, an anti-reflective film, an anti-fingerprint film, an anti-peeping film, a specular reflection film, and a 3D relief film.

4. The screen protective structure as claimed in claim 1, wherein the adhesion layers are in an electrostatic adsorption type or a pasting type.

5. The screen protective structure as claimed in claim 1 further comprising a release film removably covering on the adhesion layer of the bottom screen protector.

6. The screen protective structure as claimed in claim 1, wherein the adhesion layer of the bottom screen protector is for disposing on a screen of an electronic device.

7. The screen protective structure as claimed in claim 6, wherein the electronic device is a notebook computer, a camera, a TV, an e-book, a cell phone, a calculator, a watch, a phone, a refrigerator, a portable media player, a portable game console, a tool machine, a PDA, a handheld GPS, or a display.

8. The screen protective structure as claimed in claim 1 further comprising a protective film and an adhesion layer bonded on the protective film, and the said adhesion layer bonded on the optical film of the top screen protector.

9. The screen protective structure as claimed in claim 1, wherein the each screen protector has an index plate formed on one side thereof, and the index plates are arranged side by side.

10. The screen protective structure as claimed in claim 1 further comprising a plurality of guide plates.

11. The screen protective structure as claimed in claim 10, wherein the guide plates are separately bonded on the optical films of the screen protectors.
